(19) United States
(12) Patent Application Publication
(10) Pub. No.: US 2007/0298154 A1
(43) Pub. Date: Dec. 27, 2007

(54) Flavored solid-form food product and method of preparation

(76) Inventor: William F. Aftoora, Parma, OH (US)

Correspondence Address: CURATOLO SIDOTI CO., LPA, 24500 CENTER RIDGE ROAD, SUITE 280, CLEVELAND, OH, 44145, US

(21) Appl. No.: 11/515,277

(22) Filed: Sep. 1, 2006

Related U.S. Application Data
(63) Continuation of application No. 10/049,876, filed on Jun. 7, 2002, now abandoned.
(60) Provisional application No. 60/148,976, filed on Aug. 13, 1999.
(60) Provisional application No. 60/201,040, filed on May 1, 2000.

(51) Int. Cl. A23L 1/0522; A23D 7/00

(52) U.S. Cl. 426/578; 426/613

(57) ABSTRACT

The present invention provides a flavored solid-form food product that is easily dispersible in aqueous liquids comprising an edible fat; an edible starchy material; a flavoring agent; a solidifying agent; an aqueous liquid; and optionally an edible bicarbonate. The invention also provides a method for preparing a method of preparing a pre-formed solid food product that is easily dispersible in aqueous solutions comprising heating a mixture comprising an edible fat and an edible starchy material to a temperature sufficient to produce a first molten mixture; mixing a solidifying agent and a flavoring agent with an aqueous liquid to form a second mixture; cooling said first molten mixture to a temperature sufficient to approximate the temperature of the second mixture; combining the first molten mixture with the second mixture to form a third mixture; and optionally adding an edible bicarbonate to the third mixture; introducing the third mixture into a desired mold; and cooling said third mixture to a temperature sufficient to form a solid mass.

### CROSS REFERENCE TO RELATED APPLICATIONS

The present application is a continuation of U.S. Ser. No. 10/049,876, filed Jun. 7, 2002, which is a national stage application under 35 U.S.C. §371 of PCT/US00/22045, filed Aug. 11, 2000, claims the benefit of the filing date of U.S. Provisional Patent Application No. 60/148,976, filed Aug. 13, 1999, and U.S. Provisional Patent Application No. 60/201,040, filed May 1, 2000, each of which are hereby incorporated by reference in their entireties.

### TECHNICAL FIELD OF THE INVENTION

The present invention is directed to solid-form food products. The present invention is more particularly directed to pre-formed and pre-flavored solid food products that are easily dispersible in aqueous cooking liquids to form sauces, gravies, glazes, puddings and pie fillings, and a method for preparation of the food product.

### BACKGROUND OF THE INVENTION

Starch granules traditionally have been added to other edible materials to form dissolvable dry powders to produce thickening agents for many food applications, such as sauces, gravies and the like. For example, these dry powders can be dry gravy mixes, such as beef gravy, turkey gravy, and chicken gravy, dry sauce mixes, such as spaghetti sauces, dry salad dressing mixes, dry pudding mixes, and dry soup mixes. These dry powder food products require reconstitution with hot water to disperse or dissolve the powder, thus forming the final food product.

It has been desirable to either chemically or physically modify starch to provide starch granules that can withstand heating and cooling conditions associated with food preparation and storage. Granular starch can be physically modified by heating the starch granules in excess water above the gelatinization temperature to produce a viscous paste. However, these pregelatinized starch products do not readily disperse in water and form agglomerated masses, giving the end food product a lumpy consistency.

A roux is a basic cooking ingredient that is used in French, Creole, Continental and Italian cooking, and is used as a base or thickening agent for the preparation of gravies, soups, sauces and gumbos. In addition, the fast food industry has recently begun to rely the use of roux for the preparation of various fast food items.

Traditionally, a roux is prepared by cooking a mixture of a starchy material, such as flour, and a fat, such as butter or vegetable oil. The flour and fat are combined in suitable proportions and amounts, and are heated for varying periods of time, depending on the ultimate consistency and color of the roux that is desired by the preparer.

There are generally three types of roux: a white roux, a blonde roux and a brown roux. The color of the roux is determined by the length of time the mixture is cooked. Both the white roux and the blonde roux are made with butter as the source of fat. The white roux is cooked until it begins to turn beige in color and the blond roux is cooked until it turns pale golden. Both the blonde roux and the white roux are used to thicken white sauces. The brown roux is generally prepared with butter, flour and drippings of beef or pork fat. The brown roux is usually cooked to a deep golden brown and is used to thicken dark soups and sauces. For a complete discussion of roux, see The Food Lover's Companion, Second Edition, by Sharon Tyler Herbst.

Preparation of a roux is typically time consuming and considerable care must be taken to avoid overcooking the roux and to achieve a desired smooth consistency. The heating and stirring of the roux is essential to the preparation of a quality roux. Unless the butter and flour are stirred to distribute the heat to allow the starch granules to swell evenly, they will later fail to absorb the liquid. Using too high a heat attempting to hurry the preparation of the roux will result in burning the flour, giving it a bitter taste. Burning the flour will also shrink the starch, making it incapable of continuing to swell.

There have been numerous attempts to provide roux products and methods of preparation that are useful for the preparation of thick sauces, soups and gravies that are convenient to prepare and that overcome the above problems associated with roux preparation.

For example, U.S. Pat. No. 3,966,993 to Luck, discloses a process for making a sauce bar that is covertible on mixing with aqueous liquid into an edible sauce which comprises: intimately mixing together 40 to 60 parts of melted, edible emulsified triglyceride fat having acyl radicals of preponderantly C₁₆ to C₁₈ chain length and having a Wiley melting point of about 100° to 125° F. and a minimum of 30% Solid Fat Index at 70° F., and 15 to 40 parts of farinaceous flour, and 5 to 45 parts of condiment solids having particle size no substantially greater than about 30 microns; tempering the resulting mixture in an agitated tempering zone until fat crystals are generated, forming a solid bar of the tempered mixture under conditions precluding complete remelting of said fat crystals; and cooling the resulting bar until it is dimensionally stable at room temperature.

The sauce bar of the Luck reference may contain condiment solids including spices, salt, sugar, onion, white pepper, powdered onion, curry powder, turmeric, ginger, cayenne, pulverized bouillon, powdered mustard, powdered garlic, powdered mushrooms, cheese flavor, ground celery seed, tomato crystals, lemon crystals, corn syrup solids, non-fat dry milk solids, dried egg or egg fractions, meat powder, fish powder, edible cellulose, proteinaceous material, such as soya protein. The casted bar is reconstituted with an aqueous liquid, such as water, milk, cream, vinegar, wine, lemon juice and syrup solutions.

U.S. Pat. No. 3,652,299 to Penton, discloses a process of making brittle solid food sauce concentrates comprising: providing from 20 to 40 percent by weight of an edible fat, from 20 to 40 percent by weight of a starch and from 20 to 40 percent by weight of food sauce flavoring; and dispersing the fat, starch and food flavorings together, cooling the mixture to solidify. Some food flavorings include dry milk, salt, pepper, cheese, mushrooms, pimento and dehydrated vegetables.

In Bos, U.S. Pat. No. 4,415,599, discloses a dry mix composition containing a starch-containing thickening agent, flavoring, coloring and nutritional agents which upon the addition to water reconstitutes to form a gravy or sauce, the improvement consisting essentially of including in the dry mix from 15 to 40 percent by weight of said thickening agent, and maltodextrin in an amount sufficient to provide a weight ratio of maltodextrin to thickening agent of at least 1:1, whereby the dry mix may be added to boiling water to form a gravy or sauce substantially free of lumps. The thickening agent is selected from a variety of starches such as wheat flour, potato flour, rice flour and the like. The flavoring agents may be fats, hydrolyzed vegetable protein, and meat flavors.

Willi et al, U.S. Pat. No. 4,363,824, discloses a process for the production of a food base instantaneously dispersable in water which comprises: (a) mixing a flour material and a hot molten fat in a ratio from 55:45 to 80:20 by weight; (b) subjecting the mixture to controlled cooling in order to obtain crystal modification in the fat so that the liquid fat content in the fat at approximately 25° to 35° C. is less than 50 percent; whereby the food based obtained, after dispersion in water, has a lump count of less than 2 percent by weight based on the total weight of the food base and a viscosity in the range of from 20 Mpa to 35 Mpa, based on 12 grams of the food base dispersed in 150 ml of water. The patent discloses that the food base of flour material and fat stays free-flowing at room temperature. It is essential that the fat used has a liquid fat content at 25° to 35° C. low enough to ensure that the product does not agglutinate on storage at a maximum temperature for a certain climatic zone (room temperature). The addition of a flavoring agent to the food base composition is not disclosed.

Seewi et al, U.S. Pat. No. 4,568,551 discloses a process for the preparation of a dehydrated base product for thickened sauces and soups which disperses in hot water without forming lumps, consisting of the steps of adding from 25 to 75 percent by weight of a starchy material to 80 to 25 percent by weight of melted edible fat having a melting point of about 45° C. to form an essentially homogenous mixture; adding to said mixture 0.5 to 15 percent by weight of water while maintaining the mixture at a temperature not to exceed 100° C.; heating the mixture at 90 to 155° C. for 0.2 to 5 hours; cooling to room temperature and grating to form a free flowing dehydrated base product. The product can contain other ingredients such as bouillon, condiments, fruit juices, vegetable juices, pureed fish and meat, onions, carrots, leeks, parsley and celery.

Seeds et al, U.S. Pat. No. 5,536,522, discloses a reduced oil protein roux having a peak flavor comprised of a caramelized protein source and a shortening mixture having a ratio of about 80:20 to about 20:80 by weight of the protein source to shortening, the roux exhibiting a peak flavor as a result of heating, mixing, caramelizing and quenching. The patent discloses that the protein source may be selected from grain protein, such as wheat gluten, vegetable protein, such as isolated soy protein, dairy protein, such as egg protein and cheese protein, and animal protein, such as beef, pork, chicken, and fish protein.

Seeds, U.S. Pat. No. 5,206,046 discloses a roux base having a definitive flavor comprising a caramelized flour and shortening mixture having a ratio from about 75:25 to about 25:75 percent by weight of flour to shortening, the roux base exhibiting a L color in the range of form about 30 to about 70 as a result of heating, mixing, caramelizing and quenching of the mixture, and the color being correlatable to the definitive flavor. The flour may be selected from wheat, corn, potato, rice and vegetable sources. The fat that is used can be either animal or vegetable or a blend of both and can have different levels of unsaturation. This patent only discloses a roux composition comprising flour and fats, but not an additional flavoring agent. The flavor is imparted by the length of cooking the composition.

Seeds, U.S. Pat. No. 5,145,705, discloses a fried flavor roux base comprising a caramelized flour and shortening mixture having a ratio of from about 75:25 to about 25:75 percent by weight flour to shortening, the roux base exhibiting a color range wherein L ranges from about 20 to about 75; a ranged from about 5 to about 10; and b ranges from about 6 to about 20 as a result of heating, mixing, caramelizing and quenching of the mixture, the color being correlatable to definitive flavor. The patent discloses two main ingredients, namely flour and fats.

Sugisawa et al, U.S. Pat. No. 5,208,062, discloses a method for producing a roux comprising heating and kneading a starting material comprised of fats and oils and farinaceous materials in a twin-screw extruder at a temperature of 90° to 150° C. for 1 to 12 minutes, at least one of a reverse screw and a paddle screw being disposed in at least one portion of a heating and kneading zone of the twin-screw extruder, the amount of fats and oils in the starting material being 15 to 50 percent by weight. Any edible fats and oils can be used, but tallow, palm oil, lard and butter are specifically disclosed. The farinaceous materials include wheat flour or any other starch source. It is also disclosed that salt, sugar, seasonings, spices such as curry powder and pepper, soy sauce, worcester sauce, milk and tomato puree can be added to the roux composition.

Amamoto et al, U.S. Pat. No. 4,844,938 discloses a method for producing a roux comprising the steps of drying flour with hot air at 80° to 200° C. until the moisture content thereof is reduced to 0.5 to 10 percent by weight and to a level lower than that required to cause swelling of starch in the flour, adding fats and oils having a melting point of not more than 55° C. in a weight ratio of flour to fats and oils of 1/5 to 1/0.25 and then heating and mixing them at a temperature of 65° to 130° C. for 5 to 60 minutes. The patent discloses that the preferred flour for drying is wheat flour, and that the fats and oils may be those derived from animals or plants. The patent also discloses that the taste of the roux can be improved by adding additives such as seasonings, processed milk products, extracts and starch during the heating process. The heated roux is then cooled produce a solid roux product.

Jaworski et al, U.S. Pat. No. 4,126,710, discloses a process for preparing a sauce mix comprising forming a mixture by heating fat to an elevated temperature range and adding thereto a particulate moisture-containing farinaceous material, hard fat and flavorings, maintaining the mixture substantially within said elevated temperature range for a time sufficient to evaporate a substantial portion of said moisture and to obtain a thick particulate mixture having a dough-like consistency wherein the farinaceous particles are covered with the liquid fat, cooling the heated mixture to within a temperature range wherein the mixture reverts to a liquefied state and then further cooling the mixture to form a plastic mass wherein the farinaceous particles and crystallized fat glycerides are interspersed. The cooled mixture assumes a plastic or solid configuration at room temperature and may be formed into any desired shape such as bars, blocks, rod or flakes.

Bienvenu, U.S. Pat. No. 5,858,426, discloses a meltable food product consisting essentially of water, a base food flavoring agent, and a solidifying agent selected from the group consisting of gelatin, gum extract, and aspic powder. The meltable food product is supplied in the form of a sheet. The invention further discloses that the meltable food product may be melted, collected and thickened with a roux to make a thicker sauce or gravy.

As mentioned above, the preparation of a quality roux by a chef or home consumer takes a great deal of time, care, attention and patience. As a result of the inconsistencies with the use of dry powers containing starch granules and the demanding factors associated with the preparation of a roux, it is believed to be desirable to chefs in the food preparation and restaurant industry and to home consumers to have a flavored solid-form food product that is easily dispersible in a variety of common cooking liquids for use as a roux, base or thickening agent for foods, and for the preparation of sauces, gravies, glazes, puddings, pie fillings, and the like.

### SUMMARY OF THE INVENTION

It is, therefore, an object of the present invention to provide a flavored solid-form food product that is capable of providing a sauce or gravy having a smooth consistency, without the formation of lumps.

It is another object of the present invention to provide a flavored solid-form food product that is easily dispersible in conventional cooking liquids.

It is another object of the present invention to provide a method for the preparation of a flavored solid-form food product.

It is another object of the present invention to provide a flavored solid-form food product having a low acid content.

The foregoing objects, together with the advantages thereof over the known art relating to food products, namely food bases, and dry mix products, which shall become apparent from the specification which follows, are accomplished by the invention as hereinafter described and claimed.

The present invention, therefore, provides a flavored solid-form food product that is easily dispersible in aqueous liquids comprising an edible fat; an edible starchy material; a flavoring agent; a solidifying agent; and an aqueous liquid.

In one preferred embodiment, the present invention provides a flavored solid-form food product that is easily dispersible in aqueous liquids comprising about 1 part of an edible fat; about 1 to about 5 parts of an edible starchy material; about 0.25 to about 15 parts of a flavoring agent; about 0.25 to about 5 parts of a solidifying agent; and about 1 to about 5 parts of an aqueous liquid.

In another preferred embodiment, the present invention provides a flavored solid-form food product that is easily dispersible in aqueous liquids comprising about 1 part of an edible fat; about 1 to about 2.5 parts of an edible starchy material; about 0.25 to about 4.5 parts of a flavoring agent; about 0.25 to about 1.25 parts of a solidifying agent; and about 1 to about 3 parts of an aqueous liquid.

The present invention further provides a flavored solid-form food product that is easily dispersible in aqueous liquids comprising an edible fat; an edible starchy material; a flavoring agent; a solidifying agent; an aqueous liquid; and an edible bicarbonate.

In one preferred embodiment, the present invention further provides a flavored solid-form food product that is easily dispersible in aqueous liquids comprising about 1 part of an edible fat; about 1 to about 5 parts of an edible starchy material; about 0.25 to about 15 parts of a flavoring agent; about 0.25 to about 5 parts of a solidifying agent; about 1 to about 5 parts of an aqueous liquid; and about 0.01 to about 1 part of an edible bicarbonate.

In another preferred embodiment, the present invention further provides a flavored solid-form food product that is easily dispersible in aqueous liquids comprising about 1 part of an edible fat; about 1 to about 2.5 parts of an edible starchy material; about 0.25 to about 4.5 parts of a flavoring agent; about 0.25 to about 1.5 parts of a solidifying agent; about 1 to about 3 parts of an aqueous liquid; and about 0.01 to about 0.05 parts of an edible bicarbonate.

The invention also provides a method for preparing a flavored solid-form food product that is easily dispersible in aqueous solutions comprising heating a mixture comprising an edible fat and an edible starchy material to a temperature sufficient to produce a first molten mixture; mixing a solidifying agent and a flavoring agent with an aqueous liquid to form a second mixture; cooling said first molten mixture to a temperature sufficient to approximate the temperature of said second mixture; combining the first molten mixture with the second mixture to form a third mixture; and optionally adding an edible bicarbonate to the third mixture; introducing the third mixture into a desired mold; and cooling said third mixture to a temperature sufficient to form a solid mass.

In one preferred embodiment, the invention also provides a method for preparing a flavored solid-form food product that is easily dispersible in aqueous solutions comprising heating a mixture comprising 1 part of an edible fat and about 1 to about 2.5 parts of an edible starchy material to a temperature sufficient to produce a first molten mixture; mixing about 0.25 to about 1.5 parts of a solidifying agent and about 0.25 to about 4.5 parts of a flavoring agent with about to 1 about 3 parts of an aqueous liquid to form a second mixture; cooling said first molten mixture to a temperature sufficient to approximate the temperature of said second mixture; combining the first molten mixture with the second mixture to form a third mixture; and optionally adding about 0.01 to about 0.05 parts of an edible bicarbonate to the third mixture; introducing the third mixture into a desired mold; and cooling said third mixture to a temperature sufficient to form a solid mass.

### DETAILED DESCRIPTION OF THE INVENTION

The preparation of a roux requires a great deal of care, substantial ability and involves a laborious cooking procedure. It has now been discovered that a pre-formed and pre-flavored solid food product can be used to avoid having to prepare a roux, gravy or sauce at the time of food preparation and to avoid the inconsistencies inherent in a roux, gravy or sauce product. The food product of the present invention is extremely useful to restaurant chefs, institutional food preparation, such as in schools and hospitals, large-scale commercial food preparation, and to the home consumer having little time to prepare a conventional roux.

The food product of the present invention is a pre-flavored and pre-formed solid food product that is easily dispersible in aqueous cooking liquids to form sauces, gravies, glazes, puddings, pie fillings and the like. The food product of the present invention is comprised of homogenous mixture of five basic components, namely an edible fat, an edible starchy material, a desired flavoring agent, a solidifying agent and an aqueous cooking liquid.

In one preferred embodiment, the food product is the product of the mixture of about 1 part of an edible fat; about 0.5 to about 5 parts of an edible starchy material; about 0.25 to about 15 parts of a flavoring agent; about 0.25 to about 5 parts of a solidifying agent; and about 1 to about 5 parts of an aqueous liquid. The parts of the components of the food product are parts by volume, based on the volume of the fat component of the food product.

In another preferred embodiment, the food product is the product of the mixture of about 1 part of an edible fat; about 1 to about 2.5 parts of an edible starchy material; about 0.25 to about 4.5 parts of a flavoring agent; about 0.25 to about 1.5 parts of a solidifying agent; and about 1 to about 3 parts of an aqueous liquid. The parts of the components of the food product are parts by volume, based on the volume of the fat component of the food product.

The edible fats that are useful for preparing the solid food product of the present invention are selected from animal fats, vegetable fats and artificial fat substitutes. Useful edible fats include, but are not limited to, animal fats such as butter, lard, chicken fat, beef fat, pork fat, lamb fat, duck fat, goose fat, fish oils and the like.

Suitable vegetable fats include, but are not limited to, margarine, vegetable shortening and full and partially hydrogenated cooking oils, such as vegetable oils. The vegetable oils that are useful in the present invention include corn oil, sunflower oil, olive oil, cottonseed oil, canola oil, grapeseed oil, rapeseed oil, palm oil, soybean oil, peanut oil, walnut oil, and the like. Alternatively, it is envisioned that commercially available artificial fat substitutes can also be used as the fat in the food product of the present invention.

The edible starchy material that is useful in the preparation of the solid roux product of the present invention include, but are not limited to, wheat flour, rice flour, potato flour, corn flour, corn starch, rice starch, arrow root, tapioca and mixtures thereof.

The solid-form food product of the present invention contains an effective amount of a solidifying agent to effect solidification of the food product upon cooling to room temperature or lower. As mentioned hereinabove, the food product of the present invention contains a solidifying or gelling agent. Solidifying agents that are useful in the food product of the present invention include gelatin, pectin, guar gum, xanthan gum, locust bean gum, gum arabic, cellulose gums, edible agar, tracaganth, carrageenan, alginate, modified food starch, mixtures thereof, and the like. Where guar gum, xanthan gum, locust bean gum, gum arabic, cellulose gums and edible agar are employed as the solidifying agent, it may be necessary to moisten the solidifying agent with a moistening agent, such as propylene glycol, to facilitate dispersion of the solidifying agent in the roux product.

Gelatin is preferably used as the solidifying agent in the food product of the present invention. Gelatin is a mixture of proteins that is obtained from the hydrolysis of collagen from animal tissue, especially bones. The use of the gelatin as the solidifying agent in the mixture also imparts a smooth consistency and easy pourability to the molten food product. The inclusion of the gelatin in the mixture also inhibits the separation of the fat component of the mixture from the roux products, thus avoiding “skimming” or the formation of a layer of fat (i.e., “fat cap”) on the surface of the solidified food product.

As mentioned hereinabove, the food product of the present invention is pre-flavored. Many different types of flavoring agents can be utilized to prepare a variety of food products having different flavors or tastes. For example, the flavoring agents may include, but are not limited to, beef base, pork base, ham base, veal base, chicken base, turkey base, fish base, seafood bases, including lobster, clam, crab, scallop, shrimp, oyster, and crawfish, vegetable flavoring agents, including tomato, onion, mushroom and the like, egg, cheese powder, cream (báchemel), milk, buttermilk, honey molasses, coconut milk, liquors, chocolate cocoa, cane sugar, brown sugar, corn syrup, high fructose corn syrup, fruits, concentrated and non-concentrated fruit juices, and artificial fruit and vegetable flavorings. The flavorings may be provided in a form including, but not limited to, a powder, liquid, syrup, paste, base, bouillon, or puree.

The food product of the present invention also comprises an aqueous liquid. Preferably, the food product comprises from about 1 to about 3 parts of an aqueous liquid. Suitable aqueous liquids include, but are not limited to, water, milk, cream, fruit juices, vegetable juices, vinegar, vegetable broth or stock, meat cook-out juices or drippings, fish cook-out juices or drippings, seafood cook-out juices or drippings, and cooking alcohols. Vegetable broth or stock is a liquid that conventionally contains water, onions, celery, and carrots. Other vegetables and ingredients, such as leeks, crushed tomato, parsley, olive oil, herbs, salt and spices, may be added to the vegetable broth to vary the flavor of the broth. The use of vegetable broth to dissolve the solidifying agent imparts additional flavor and color to the resulting food product.

In another embodiment, the present invention provides a flavored solid-form food product that is easily dispersible in aqueous liquids comprising an edible fat; an edible starchy material; a flavoring agent; a solidifying agent; an aqueous liquid; and an edible bicarbonate.

In one preferred embodiment, the food product is the product of the mixture of about 1 part of an edible fat; about 0.5 to about 5 parts of an edible starchy material; about 0.25 to about 15 parts of a flavoring agent; about 0.25 to about 5 parts of a solidifying agent; about 1 to about 5 parts of an aqueous liquid; and about 0.01 to about 1 part of an edible bicarbonate. The parts of the components of the food product are parts by volume, based on the volume of the fat component of the food product.

In a variation of this embodiment, the present invention provides a flavored solid-form food product that is easily dispersible in aqueous liquids comprising about 1 part of an edible fat; about 1 to about 2.5 parts of an edible starchy material; about 0.25 to about 4.5 parts of a flavoring agent; about 0.25 to about 1.5 parts of a solidifying agent; about 1 to about 3 parts of an aqueous liquid; and about 0.01 to about 0.05 parts of an edible bicarbonate.

The term “edible bicarbonate” used throughout the specification refers to the bicarbonate salts, such as sodium bicarbonate, potassium bicarbonate and calcium bicarbonate. The preferred edible bicarbonate is sodium bicarbonate.

The main advantage of the inclusion of an edible bicarbonate to the food product is to produce a food product having a lower acidity for individuals that are sensitive to high levels of acidity in foods. Addition of an edible bicarbonate to the food product of the present invention allows individuals with low tolerance for acidic foods or with open mouth sores to comfortably consume the acidic foods prepared with the food product without irritation to the mouth wounds and sores.

The amount of the edible bicarbonate to be added to the food product of the present invention should be an amount effective to substantially neutralize the acidity of the solid form food product. In one embodiment, the amount of the edible bicarbonate to be added to the food product of the present invention should be an amount effective to raise the pH of the food product from about 1 to about 3 pH units. The resulting food product can be used to prepare low acidity foods, such as sauces, gravies and gumbos, and does not alter the taste of the food. The low acidity gravies and sauces can be consumed without pain or discomfort by individuals having a hypersensitivity to acid or who have open mouth wounds or sores.

The invention also provides a method of preparing a flavored solid-form food product that is easily dispersible in aqueous solutions comprising heating a mixture comprising an edible fat and an edible starchy material to a temperature sufficient to produce a first molten mixture; mixing a solidifying agent and a flavoring agent with an aqueous liquid to form a second mixture; cooling said first molten mixture to a temperature sufficient to approximate the temperature of said second mixture; combining the first molten mixture with the second mixture to form a third mixture; and optionally adding an edible bicarbonate to the third mixture; introducing the third mixture into a desired mold; and cooling said third mixture to a temperature sufficient to form a solid mass.

In a variation of this embodiment, the present invention further provides a method of preparing the flavored solid-form food product. The preferred method of preparation of the food comprises heating about 1 part of the edible fat to a temperature sufficient to produce a molten fat. About 1 to about 2.5 parts of the edible starchy material is added to the molten fat and vigorously mixed to produce a first homogenous mixture of molten fat and starchy material.

About 0.25 to about 1.5 parts of a suitable solidifying agent is mixed with about 1 to about 3 parts of an aqueous liquid. Suitable aqueous liquids include, but are not limited to, water, milk, cream, fruit juices, vegetable juices, vinegar, beef stock, poultry stock, fish or seafood stock, vegetable broth or stock, meat cook-out juices, fish cook-out juices, seafood cook-out juices, and cooking alcohols. As mentioned hereinabove, the vegetable broth or stock contains water, onions, celery, carrots, and may also contain leeks, crushed tomato, parsley, olive oil, herbs, salt and spices. The use of vegetable broth to dissolve the solidifying agent imparts additional flavor and color to the resulting food product. About 0.25 to about 4.5 parts of the desired flavoring agent is added to the mixture of the solidifying agent/aqueous liquid mixture to form a second mixture.

The first molten mixture of fat and starch is cooled to a temperature sufficient to approximate the temperature of said second mixture (preferably from about 100° F. to about 150° F.), and is subsequently combined with the second mixture, containing the solidifying agent/aqueous liquid/flavoring agent, to form a third mixture. The third mixture comprises the fat, starchy material, solidifying agent, flavoring agent and aqueous liquid components of the food. Optionally about 0.01 to about 0.05 parts of an edible bicarbonate is added to the third mixture. The third mixture is poured into a desired mold and cooled the mixture to a temperature sufficient to form a solid mass or solid food product.

If the solid-form food product is intended to be reconstituted to form a pudding or pie filling, it may advantageous to heat the third mixture prior to introducing the mixture into the mold. Preferably, the third mixture is additionally heated in a temperature range of about 140° F. to about 250° F., preferably form about 160° F. to about 230° F., and more preferably from about 180° C. to about 200° F. for a period of time of about 10 seconds to about 10 minutes.

According to the present invention, a pre-formed solid food product can be prepared by initially heating 1 part of an edible fat source to produce a molten fat. About 1 to about 2.5 parts of the starchy material is then added to the molten fat to product a mixture of fat and starch. The starchy material, usually a flour, is thoroughly blended into the molten fat using conventional mixing techniques. The fat/flour mixture is cooked at a temperature of from about 220° F. to about 250° F. for a total of about 6 to about 20 minutes, with continuous mixing or intermittent mixing at 2 minute intervals. Any conventional means of mixing can be used. However, it is preferable to prepare the roux product with a high speed immersible blender to facilitate optimal blending of the ingredients. While cooking the fat/flour mixture for about 6 to about 20 minutes, a separate second mixture is prepared by mixing about 0.25 to about 1.5 parts of the solidifying agent, preferably gelatin, to a desired aqueous liquid and homogenously blended. About 0.25 to about 4.5 parts of a flavoring agent is added to the second mixture to obtain a mixture of solidifying agent/flavoring agent/aqueous liquid. The first mixture of molten fat and starchy material is combined with the second mixture, containing the solidifying agent, flavoring agent and aqueous liquid, and mixed with conventional mixing techniques to form a third mixture. The third mixture is introduced into a suitable mold, and is allowed to cool to a temperature sufficient to form a solid mass.

The solid food product of the present invention can be used to prepare or thicken sauces, gravies, soups, gumbos, glazes, puddings and pie fillings having a excellent taste, texture, and consistency. Preferably, about 1 part of the solid food product of the present invention is added to about 4 to about 5 parts of a conventional aqueous cooking liquid. The cooking liquid and the solid food product is heated until it melts into the liquid to form a thick sauce or gravy. The flavored solid-form food of the present invention is easily dispersible in various cooking liquids, such as water, milk, cream, vinegar, wine, fruit juices, meat stocks, poultry stocks, fish stocks, vegetable broths or stock and cooking alcohols. The resulting flavorful sauce, gravy and glazes can be applied to any food of choice. In addition, flavorful puddings and pies fillings can be prepared by reconstituting the solid-form food product of the present invention.

The following examples are intended to be for illustrative purposes only. The examples set forth should not be construed as limiting the scope of the invention in any manner.

### GENERAL EXPERIMENTAL

### Example 1

A solid beef roux was prepared according to the present invention. Briefly, 4 fluid ounces of butter was melted in a large cooking skillet over a moderately low heat to produce a molten fat. 6 fluid ounces of flour was added to the molten fat, an mixed thoroughly using a standard hand held kitchen mixer on low speed. The fat/flour mixture was cooked at a temperature of 225° F. for a total of 10 minutes, with thorough mixing with the hand held immersible blender at 2 minute intervals. After about 10 minutes of cooking the molten fat/flour mixture, 4 fluid ounces of corn starch was added to the molten mixture and thoroughly mixed by conventional techniques. The molten fat/flour/corn starch mixture was heated for 225° F. for a total of 2 minutes, and then removed from the heat. The molten mixture is then cooled to a temperature of about 140° F. to approximate the temperature of the second mixture.

While the fat/flour mixture was cooking, a second mixture containing gelatin, beef base and vegetable broth was prepared. 0.5 fluid ounces of gelatin was added to 2 fluid ounces of cold vegetable broth to “bloom” the gelatin. Once the gelatin had bloomed, 2 fluid ounces of hot vegetable broth and 1 fluid ounce of a browning agent were added to the mixture to dissolve the gelatin particles. 2 fluid ounces of beef flavoring base was added to the dissolved gelatin and mixed using a hand held immersible blender until a smooth consistency was achieved.

The first molten mixture of fat and flour was blended into the second mixture of gelatin and beef flavoring base to obtain the final mixture, which was introduced into a suitable plastic mold. The molten roux was cooled to a temperature sufficient to form a solid mass. The molten beef roux prepared according to the present invention had a smooth texture, without the formation of any lumps. The molten mixture was easily pourable or cast into the plastic mold. Once solidified, the beef roux product exhibited a smooth surface appearance, without any indication of fat skim or “fat cap” on the surface that usually results from the “bleeding” of the fat component from the roux.

### Example 2

A solid chicken roux was prepared according to the present invention. Briefly, 4 fluid ounces of butter was melted in a large cooking skillet over a moderately low heat to produce a molten fat. 6 fluid ounces of flour was added to the molten fat, an mixed thoroughly using a standard hand held immersible blender on low speed. The fat/flour mixture was cooked at a temperature of 225° F. for a total of 10 minutes, with thorough blending. After about 10 minutes of cooking the molten fat/flour mixture, 4 fluid ounces of corn starch was added to the molten mixture and thoroughly mixed by conventional techniques. The molten fat/flour/corn starch mixture was heated for 225° F. for a total of 2 minutes. The molten mixture was removed from the heat and cooled to 140° F.

While the fat/flour mixture was cooking, a second mixture containing gelatin, chicken base and vegetable broth was prepared. 0.5 fluid ounces of gelatin was added to 2 fluid ounces of cold vegetable broth to “bloom” the gelatin. Once the gelatin had bloomed, 3 fluid ounces of hot vegetable broth were added to the mixture to dissolve the gelatin particles. 2 fluid ounces of chicken flavoring base was added to the dissolved gelatin and mixed using a hand held blender until a smooth consistency was achieved.

The molten mixture of fat and flour was blended to the mixture of gelatin and chicken flavoring base to obtain the final mixture, which was introduced into a suitable plastic mold. The molten roux was cooled to a temperature sufficient to form a solid mass. The molten chicken roux prepared according to the present invention had a smooth texture, without the formation of any lumps. The molten mixture was easily pourable or cast into the plastic mold. Once solidified, the chicken roux product exhibited a smooth surface appearance, without any indication of fat skim or “fat cap” on the surface that usually results from the “bleeding” of the fat component from the roux.

### Example 3

A solid white roux (i.e. báchamel) was prepared according to the present invention. Briefly, 4 fluid ounces of butter in was melted a large cooking skillet over a moderately low heat to produce a molten fat. 6 fluid ounces of flour was added to the molten fat, an mixed thoroughly using a standard hand held immersible blender on low speed. The fat/flour mixture was cooked at a temperature of 225° F. for a total of 10 minutes, with thorough continuous blending with the hand held immersible blender at 2 minute intervals. After about 10 minutes of cooking the molten fat/flour mixture, 4 fluid ounces of corn starch was added to the molten mixture and thoroughly blended. The molten fat/flour/corn starch mixture was heated for 225° F. for a total of 2 minutes, and then removed from the heat. The molten mixture was cooled to a temperature of 140° F.

While the fat/flour mixture was cooking, a second mixture containing the gelatin and cream flavoring mixture was prepared. 0.5 fluid ounces of gelatin was added to 2 fluid ounces of cold heavy cream to “bloom” the gelatin. Once the gelatin has bloomed, 3 fluid ounces of hot heavy cream was added to the mixture to dissolve the gelatin particles.

The báchamel flavoring agent was prepared by mixing 4 fluid ounces of water with 14 fluid ounces of low-fat dry milk. The low-fat dry milk and water was mixed with a hand held blender to produce 7 fluid ounces of a thick báchamel flavoring agent. The 7 fluid ounces of dream (báchamel flavoring agent) was added to the 5 ounces of dissolved gelatin, and mixed using a hand held immersible blender until a smooth consistency was achieved.

The molten mixture of fat and flour was added to the mixture of gelatin and cream (báchamel flavoring agent) to obtain the final mixture, which was introduced into a suitable plastic mold. The molten roux was cooled to a temperature sufficient to form a solid mass. The molten báchamel roux prepared according to the present invention had a smooth texture, without the formation of any lumps. The molten mixture was easily pourable or cast into the plastic mold. Once solidified, the cream roux product exhibited a smooth surface appearance, without any indication of fat skim or “fat cap” on the surface that usually results from the “bleeding” of the fat component from the roux.

### Example 4

A solid vegetable roux was prepared according to the present invention. Briefly, 4 fluid ounces of butter was melted in a large cooking skillet over a moderately low heat to produce a molten fat. 6 fluid ounces of flour was added to the molten fat, an mixed thoroughly using a standard hand held kitchen mixer on low speed. The fat/flour mixture was cooked at a temperature of 225° F. for a total of 10 minutes, with continuous and thorough blending with an immersible blender. After about 10 minutes of cooking the molten fat/flour mixture, 4 fluid ounces of corn starch was added to the molten mixture and thoroughly blended. The molten fat/flour/corn starch mixture was heated for 225° F. for a total of 2 minutes. The molten mixture was removed from the heat and cooled to 140° F.

While the fat/flour mixture was cooking, a second mixture containing the gelatin, chicken base and vegetable broth was prepared. 0.5 fluid ounces of gelatin was added to 2 fluid ounces of cold vegetable broth to “bloom” the gelatin. Once the gelatin had bloomed, 3 fluid ounces of hot vegetable broth were added to the mixture to dissolve the gelatin particles. 6 fluid ounces of vegetable flavoring base was added to the dissolved gelatin and mixed using a hand held blender until a smooth consistency was achieved.

The molten mixture of fat and flour was blended to the mixture of gelatin and vegetable flavoring base to obtain the final mixture, which was poured into a suitable plastic mold. The molten roux was cooled to a temperature sufficient to form a solid mass. The molten vegetable roux prepared according to the present invention had a smooth texture, without the formation of any lumps. The molten mixture was easily cast into the plastic mold. Once solidified, the vegetable roux product exhibited a smooth surface appearance, without any indication of fat skim or “fat cap” on the surface that usually results from the “bleeding” of the fat component from the roux.

### Example 5

A solid cheese flavored roux was prepared according to the present invention. Briefly, 4 fluid ounces of butter was melted in a large cooking skillet over a moderately low heat to produce a molten fat. 6 fluid ounces of flour was added to the molten fat, an mixed thoroughly using a standard hand held immersible blender on low speed. The fat/flour mixture was cooked at a temperature of 225° F. for a total of 10 minutes, with continuous thorough blending an immersible blender. After about 10 minutes of cooking the molten fat/flour mixture, 4 fluid ounces of corn starch was added to the molten mixture and thoroughly mixed by conventional techniques. The molten fat/flour/corn starch mixture was heated for 225° F. for a total of 2 minutes. The molten mixture was removed from the heat and cooled to 140° F.

While the fat/flour mixture was cooking, a second mixture containing the gelatin, cheese powder and vegetable broth was prepared. 0.5 fluid ounces of gelatin was added to 2 fluid ounces of cold water to “bloom” the gelatin. Once the gelatin had bloomed, 3 fluid ounces of hot water were added to the mixture to dissolve the gelatin particles. 12 fluid ounces of water and 24 fluid ounces of cheese powder was added to the dissolved gelatin and mixed using a hand held immerisbie blender until a smooth consistency was achieved.

The molten mixture of fat and flour was blended to the mixture of gelatin and cheese flavoring to obtain the final mixture, which was poured into a suitable plastic mold. The molten roux was cooled to a temperature sufficient to form a solid mass. The molten cheese flavored roux prepared according to the present invention had a smooth texture, without the formation of any lumps. The molten mixture was easily cast into the plastic mold. Once solidified, the cheese roux product exhibited a smooth surface appearance, without any indication of fat skim or “fat cap” on the surface that usually results from the “bleeding” of the fat component from the roux.

### Example 6

A beef gravy was prepared with the solid roux product of the present invention. Briefly, about 14 fluid ounces (1 part) of the solid beef roux product of the present invention was added to about 64 fluid ounces (about 4 parts) of cold water in a conventional sauce pot. The sauce pot was placed on a stove over a moderately high temperature, and the water was heated to a boil. Once the water began to boil, the temperature was reduced to a moderately low temperature. The solid roux product of the present invention was allowed to melt into the boiling water over a period of three minutes to produce a molten gravy. The molten gravy was continuously agitated for 30 seconds with a conventional hand held whisk. The resulting gravy was removed from the heat source and allowed to cool at room temperature. The resulting product was a smooth, thick and flavorful gravy. The gravy was aesthetically pleasing with minimal fat separation or skimming.

The roux product of the present invention may be cast into a variety of three-dimensional shapes, such as cubes, blocks, rectangular bars, three-dimensional circular disks and spheres. The roux product of the present invention can be conveniently packaged in a paper wrapping, such as wax paper, in foil wrapping, or in plastic tubs, and is easily stored in a refrigerator for several days. The roux may be reheated several times to produce flavorful sauces and gravies that do not lose their taste or aesthetic appearance after multiple reheatings.

### Example 7

A solid form food product, which forms a lemon flavored pudding or pie filling upon reconstitution with a cooking liquid, was prepared according to the present invention. Briefly, 2 fluid ounces of butter was melted in a large cooking skillet over a moderately low heat to produce a molten fat. 2.67 fluid ounces of corn starch was added to the molten fat, and mixed thoroughly using a standard hand held immersible blender on low speed. The fat/flour mixture was cooked at a temperature of 225° F. for a total of 10 minutes, with continuous thorough blending an with immersible blender.

While the butter/corn starch mixture was cooking, a second mixture containing the gelatin, egg flavoring and lemon juice flavoring was prepared. 0.45 fluid ounces of gelatin was added to 2 fluid ounces of cold lemon juice to “bloom” the gelatin. Once the gelatin had bloomed, 2 fluid ounces of hot lemon juice were added to the mixture to dissolve the gelatin particles. A mixture of 2 fluid ounces of egg yolk and 6 fluid ounces of granulated sugar was added to the dissolved gelatin/lemon juice mixture and mixed using a hand held immersible blender until a smooth consistency was achieved.

The molten mixture of butter and corn starch was blended into the mixture of gelatin and lemon juice/egg flavoring to obtain the final mixture. The final mixture was heating to a temperature of about 180° F. to 2 minutes. The final mixture was then introduced into a suitable plastic mold. The molten food product was cooled to a temperature sufficient to form a solid mass. The molten lemon flavored food product prepared according to the present invention had a smooth texture, without the formation of any lumps. The molten mixture was easily introduced into the plastic mold. Once solidified, the lemon flavored food product exhibited a smooth surface appearance.

### Example 8

A solid form food product, which forms a chocolate flavored pudding or pie filling upon reconstitution with a cooking liquid, was prepared according to the present invention. Briefly, 2 fluid ounces of butter was melted in a large cooking skillet over a moderately low heat to produce a molten fat. 2.67 fluid ounces of corn starch was added to the molten fat, an mixed thoroughly using a standard hand held immersible blender on low speed. The fat/flour mixture was cooked at a temperature of 225° F. for a total of 10 minutes, with continuous thorough blending with an immersible blender.

While the butter/corn starch mixture was cooking, a second mixture containing the gelatin, chocolate cream flavoring and aqueous liquid was prepared. 0.33 fluid ounces of gelatin was added to 2 fluid ounces of cold cream to “bloom” the gelatin. Once the gelatin had bloomed, 3 fluid ounces of hot cream was added to the mixture to dissolve the gelatin particles. 4 fluid ounces of semi-sweet chocolate was melted in a double boiler. A mixture of 4 fluid ounces of granulated sugar, 0.33 fluid ounces vanilla extract, 1.6 fluid ounces of non-fat dry milk (reconstituted with 3 fluid ounces of cream), and 2 fluid ounces of egg yolk and was added to the melted semi-sweet chocolate. The resulting flavoring agent was added to the dissolved gelatin and mixed using a hand held immersible blender until a smooth consistency was achieved.

The molten mixture of butter and corn starch was blended into the mixture of gelatin and chocolate flavoring agent to obtain the final mixture. The final mixture was heated at a temperature of about 180° F. for about 2 minutes. The final mixture was then introduced into a suitable plastic mold. The molten food product was cooled to a temperature sufficient to form a solid mass. The molten chocolate flavored food product prepared according to the present invention had a smooth texture, without the formation of any lumps. The molten mixture was easily introduced into the plastic mold. Once solidified, the chocolate flavored food product exhibited a smooth surface appearance.

Based upon the foregoing disclosure, it should now be apparent that the use of the pre-formed solid food products described herein will carry out the objects set forth hereinabove. It is, therefore, to be understood that any variations evident fall within the scope of the claimed invention and thus, the selection of specific types of fats, starches, flavoring agents, preservatives can be determined without departing from the spirit of the invention herein disclosed and described. In particular, it should be understood that the food products exemplified herein according to the present invention are not necessarily limited to those having using butter or margarine as the fat component. Moreover, as noted hereinabove, other spices and flavoring agents might be substituted for the specific spices and flavoring agents exemplified hereinabove, and other ingredients may be optionally employed. Thus, the scope of the invention shall include all modifications and variations that may fall within the scope of the attached claims.

I claim:

1. A flavored solid-form food product that is easily dispersible in aqueous liquids comprising:
an edible fat;
a gelled, edible starchy material;
a flavoring agent;
a solidifying agent; and
an aqueous liquid.

2. The flavored solid-form food product of claim 1, wherein the product comprises:
about 1 part of an edible fat;
about 0.5 to about 5 parts of said edible starchy material;
about 0.25 to about 15 parts of a flavoring agent;
about 0.25 to about 5 parts of a solidifying agent; and
about 1 to about 5 parts of an aqueous liquid.

3. The flavored solid-form food product of claim 1, wherein the product comprises:
about 1 part of an edible fat;
about 1 to about 2.5 parts of said edible starchy material;
about 0.25 to about 4.5 parts of a flavoring agent;
about 0.25 to about 1.5 parts of a solidifying agent; and
about 1 to about 3 parts of an aqueous liquid.

4. The flavored solid-form food product of claim 1, wherein the edible fat is selected from the group consisting of animal fat, vegetable fat and artificial fat substitutes.

5. The flavored solid-form food product of claim 4, wherein the animal fat is selected from the group consisting of butter, lard, chicken fat, beef fat, pork fat, lamb fat, goose fat, duck fat and fish oil.

6. The flavored solid-form food product of claim 4, wherein the vegetable fat is selected from the group consisting of margarine, vegetable shortening and vegetable oil.

7. The flavored solid-form food product of claim 6, wherein the vegetable oil is selected from the group consisting of corn oil, sunflower oil, olive oil, cottonseed oil, canola oil, grapeseed oil, palm oil, soybean oil, peanut oil, and walnut oil.

8. The flavored solid-form food product of claim 1, wherein the starch is selected from the group consisting of wheat flour, rice flour, corn flour, potato flour, corn starch, rice flour, arrow root, tapioca and mixtures thereof.

9. The flavored solid-form food product of claim 1, wherein the solidifying agent is selected from the group consisting of gelatin, pectin, guar gum, xanthan gum, locust bean gum, gum arabic, edible agar, tracaganth, carrageenan, alginate, modified food starch and mixtures thereof.

10. The flavored solid-form food product of claim 1, wherein the flavoring agent is provided in the form of one selected from the group consisting of a liquid, syrup, base, powder, puree or concentrate.

11. The flavored solid-form food product of claim 1, wherein the flavoring agent is one flavor selected from the group consisting of beef, chicken, turkey, lamb, pork, fish, seafood, vegetable, cream, egg, cheese, milk, buttermilk, fruit, citrus, nut, chocolate cocoa, cane sugar, brown sugar, molasses, corn syrup, high fructose corn syrup and artificial flavorings.

12. The flavored solid-form food product of claim 11, wherein the seafood flavoring agent is selected from the group consisting of clam, oyster, lobster, shrimp, crab, scallop and crawfish.

13. The flavored solid-form food product of claim 11, wherein the vegetable flavoring agent is selected from the group consisting of tomato, mushroom, garlic, celery, leeks, carrots, parsley, onion and mixtures thereof.

14. The flavored solid-form food product of claim 1, wherein the product further contains a preservative selected from the group consisting of potassium sorbate, sodium benzoate and disodium ethylene diamine tetraacetic acid (EDTA).

15. The flavored solid-form food product of claim 1, wherein the solid-form food product is adapted to be easily dispersible in aqueous liquids selected from the group consisting of water, milk, cream, vinegar, fruit juice, vegetable juice, meat stock, poultry stock, fish stock, seafood stock, vegetable stock, meat cook-out juice, fish cook-out juice, seafood cook-out juice and cooking alcohol.

16. The flavored solid-form food product of claim 1, comprising: an edible fat; a gelled edible starchy material, a flavoring agent, a solidifying agent, an aqueous liquid, and an edible bicarbonate.

17. The flavored solid-form food product of claim 16, wherein the edible bicarbonate is selected from the group consisting of sodium bicarbonate, calcium bicarbonate and potassium bicarbonate.

18. The flavored solid-form food product of claim 17, wherein the edible bicarbonate is sodium bicarbonate.

19. A method of preparing a flavored solid-form food product that is easily dispersible in aqueous solutions comprising:
heating a mixture comprising an edible fat and an edible starchy material to a temperature sufficient to produce a first molten mixture;
mixing a solidifying agent and a flavoring agent with an aqueous liquid to form a second mixture;
cooling said first molten mixture to a temperature sufficient to approximate the temperature of said second mixture;
combining the first molten mixture with the second mixture to form a third mixture; and optionally adding an edible bicarbonate to the third mixture;
introducing the third mixture into a desired mold; and
cooling said third mixture to a temperature sufficient to form a solid mass.

20. A method of preparing a flavored solid-form food product that is easily dispersible in aqueous solutions comprising:
heating a mixture comprising 1 part of an edible fat and about 1 to about 2.5 parts of an edible starchy material to a temperature sufficient to produce a first molten mixture;
mixing about 0.25 to about 1.5 parts of a solidifying agent and about 0.25 to about 4.5 parts of a flavoring agent with about 1 to about 3 parts of an aqueous liquid to form a second mixture;
cooling said first molten mixture to a temperature sufficient to approximate the temperature of said second mixture;
combining the first molten mixture with the second mixture to form a third mixture; and optionally adding about 0.01 to about 0.05 parts of an edible bicarbonate to the third mixture;
introducing the third mixture into a desired mold; and
cooling said third mixture to a temperature sufficient to form a solid mass.
